(19) United States
(12) Patent Application Publication
(10) Pub. No.: US 2026/0254867 A1
(43) Pub. Date: Aug. 27, 2026

(54) SIGNALING AND DETERMINING PDU SET MARKINGS AND DYNAMIC TRAFFIC DATA IN QUIC HEADER EXTENSIONS

(71) Applicant: QUALCOMM Incorporated, San Diego, CA (US)

(72) Inventors: Liangping Ma, San Diego, CA (US); Imed Bouazizi, Celina, TX (US); Thomas Stockhammer, Bergen (DE); Nikolai Konrad Leung, San Francisco, CA (US); Sitaramanjaneyulu Kanamarlapudi, San Diego, CA (US); Hyun Yong Lee, San Diego, CA (US); Yih-Hao Lin, San Diego, CA (US)

(21) Appl. No.: 19/547,302

(22) Filed: Feb. 23, 2026

Related U.S. Application Data
(60) Provisional application No. 63/764,394, filed on Feb. 27, 2025.

(51) Int. Cl. H04L 65/70

(52) U.S. Cl. CPC H04L 65/70

(57) ABSTRACT

A device for receiving data via a network includes a processing system configured to: receive, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extract the PDU Set signaling information from the QUIC header extension; and use the PDU Set signaling information from the QUIC header extension to receive subsequent data of the QUIC communication session.

This application claims the benefit of U.S. Provisional Application No. 63/764,394, filed Feb. 27, 2025, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may be a radio access network (RAN), such as a 5G network. The data may be exchanged using QUIC protocol, e.g., using QUIC packets. In general, QUIC packets, including QUIC header data of the QUIC packets, are mostly encrypted. However, some data of the QUIC packets may be useful for cross-layer optimizations when exchanging QUIC packets via the RAN. For example, protocol data unit (PDU) Set marking data and/or other dynamic traffic characteristic indications may be signaled in QUIC header extensions. Per techniques of this disclosure, one or more unencrypted QUIC header extensions may be added to the QUIC packets, which may allow for exposure of PDU Set marking data, dynamic traffic characteristic indications, and/or other relevant data to the network, without compromising sensitive data of the QUIC packets.

In one example, a method of receiving data via a network includes: receiving, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extracting the PDU Set signaling information from the QUIC header extension; and using the PDU Set signaling information from the QUIC header extension to receive subsequent data of the QUIC communication session.

In another example, a device for receiving data via a network includes: a memory; and a processing system implemented in circuitry and configured to: receive, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extract the PDU Set signaling information from the QUIC header extension; and use the PDU Set signaling information from the QUIC header extension to receive subsequent data of the QUIC communication session.

In another example, a method of receiving data via a network includes: receiving, during a QUIC communication session, a QUIC packet including a QUIC header extension including dynamic traffic characteristics signaling information; extracting the dynamic traffic characteristics signaling information from the QUIC header extension; and using the dynamic traffic characteristics signaling information from the QUIC header extension to receive subsequent data of the QUIC communication session.

In another example, a device for receiving media data includes: means for receiving, during a QUIC communication session, a QUIC packet including a QUIC header extension including dynamic traffic characteristics signaling information; means for extracting the dynamic traffic characteristics signaling information from the QUIC header extension; and means for using the dynamic traffic characteristics signaling information from the QUIC header extension to receive subsequent data of the QUIC communication session.

In another example, a method of measuring delay in a network includes: sending, at a first time (T1), a first QUIC packet including a first QUIC header extension including data representative of T1, to a responding device; receiving, at a fourth time (T4), a second QUIC packet including a second QUIC header extension including data representative of T1, a second time (T2) at which the responding device received the first packet, and a third time (T3) at which the responding device sent the second QUIC packet; and calculating delay in the network based on T1, T2, T3, and T4.

In another example, a device for receiving media data includes: means for sending, at a first time (T1), a first QUIC packet including a first QUIC header extension including data representative of T1, to a responding device; means for receiving, at a fourth time (T4), a second QUIC packet including a second QUIC header extension including data representative of T1, a second time (T2) at which the responding device received the first packet, and a third time (T3) at which the responding device sent the second QUIC packet; and means for calculating delay in the network based on T1, T2, T3, and T4.

In another example, a method of measuring delay in a network includes: receiving, at a second time (T2) and from a requesting device, a first QUIC packet including a first QUIC header extension including data representative of a first time (T1) at which the requesting device sent the first QUIC packet; and sending, at a third time (T3) and to the requesting device, a second QUIC packet including a second QUIC header extension including data representative of T1, T2, and T3.

In another example, a device for measuring delay in a network includes: means for receiving, at a second time (T2) and from a requesting device, a first QUIC packet including a first QUIC header extension including data representative of a first time (T1) at which the requesting device sent the first QUIC packet; and means for sending, at a third time (T3) and to the requesting device, a second QUIC packet including a second QUIC header extension including data representative of T1, T2, and T3.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example set of network devices that may perform various aspects of the techniques of this disclosure.

FIG. 4 is a conceptual diagram illustrating an example QUIC packet. FIG. 4 depicts QUIC packet 230 including QUIC header 232 including QUIC header extension 234.

FIG. 5 is a block diagram illustrating an example QUIC header extension including PDU Set information per techniques of this disclosure.

FIG. 6 is a call flow diagram illustrating an example method for negotiating use of QUIC header extensions per techniques of this disclosure.

FIG. 7 is a conceptual diagram illustrating an example of use of QUIC packets including QUIC header extensions including PDU Set marking information per techniques of this disclosure.

FIG. 8 is a call flow diagram illustrating an example method for measuring end-to-end delay per techniques of this disclosure.

FIG. 9 is a flowchart illustrating an example method of constructing and sending a QUIC packet including a QUIC header extension per techniques of this disclosure.

FIG. 10 is a flowchart illustrating an example method of receiving a QUIC packet including a QUIC header extension and using data of the QUIC header extension to receive data of a QUIC communication session per techniques of this disclosure.

### DETAILED DESCRIPTION

In general, this disclosure describes techniques for transmitting data via a network, such as a radio access network (RAN). In some techniques, a data burst is defined as a set of multiple protocol data units (PDUs) generated and sent by an application such that there is an idle period between two data bursts. A data burst can include one or more PDU Sets. A PDU Set may include one or more PDUs carrying payload data for a common unit of information generated at the application level (e.g., video frames, video slices, metadata, or the like).

While Real-time Transport Protocol (RTP) is often used to transfer media data via a network, another transmission protocol is QUIC, per Iyengar et al., “QUIC: A UDP-Based Multiplexed and Secure Transport,” Internet Engineering Task Force (IETF), RFC 9000, May 2021, available at datatracker.ietf.org/doc/html/rfc9000. This disclosure describes techniques that may be used with QUIC to signal unencrypted application layer information, e.g., in a QUIC header extension. In particular, QUIC packet payloads are encrypted, such that PDU Set information is not exposed to the network if carried in QUIC packet payloads. The QUIC header is also mostly encrypted, except for a small number of fields.

Thus, this disclosure describes techniques by which unencrypted application layer information, such as PDU Set information, may be signaled when using QUIC for transport of, e.g., encoded video data. Per this disclosure, the application layer information may be signaled in an unencrypted manner, where the application layer information may include information that is useful for cross-layer optimizations, such as PDU Set information, burst information (e.g., time between bursts, minimum time between bursts, idle period information, burst size, or the like), or other such information.

In general, QUIC provides fast connection setup, good support for mobility (e.g., using connection migration), mitigation of head-of-line blocking, and native support for encryption (e.g., Transport Layer Security (TLS)). However, QUIC packets do not conventionally directly expose application layer information that can be used for cross-layer optimization. Also, QUIC packet headers are generally encrypted except for a few fields, such as a version field, a connection ID, and a spin bit.

For QUIC packets carrying media data of a media communication session, there are techniques for conveying PDU Set information to network devices, such as a user plane function (UPF) device. These techniques generally involve constructing a secure network tunnel between a QUIC sender (such as an application server (AS) device) and a network entity (such as the UPF) to send the PDU Set information. For example, the PDU Set information may be sent as encrypted metadata over a Media over QUIC (MoQ) transport. However, this would increase system complexity, because an additional connection would be established explicitly between the AS device and the UPF device. While this seemingly addresses security concerns (because only the two endpoint devices, the AS device and the UPF device, are trusted), that motivates end-to-end encryption in QUIC, but actually may not, because application information that needs to be protected end-to-end is exposed to a third party (namely, the UPF device) via the tunnel, although the QUIC packet itself does not directly expose this information.

The techniques of this disclosure include a direct solution to the QUIC protocol. In particular, per techniques of this disclosure, QUIC packets may be formed to include QUIC header extensions on top of the conventional QUIC header. The QUIC header extensions may include one or more unencrypted QUIC header extensions including data to be exposed to the network, such as PDU Set information, data burst information, or other such information that may be used for cross-layer optimization. These techniques also allow the application to determine whether to use these techniques based on security needs for a given implementation or scenario.

Encrypted transport protocols, such as QUIC, may offer robust security by shielding payload data and packet headers from inspection by intermediate network elements. While beneficial for privacy, this encryption creates a barrier for Radio Access Networks (RANs) or other network devices attempting to optimize traffic delivery. For instance, a base station scheduling radio resources cannot discern Protocol Data Unit (PDU) Set boundaries, identify data bursts, or determine the relative importance of media packets within an encrypted stream. Lacking this application-layer visibility, the network cannot effectively prioritize high importance frames during congestion or align transmission schedules with user equipment (UE) power-saving cycles. Conventional solutions often resort to establishing separate, secure tunnels between application servers and network functions to convey this metadata, which can result in signaling latency and deployment complexity.

To address these challenges, the techniques of this disclosure introduce the use of unencrypted QUIC header extensions to carry delay-sensitive application-layer information directly within the transport packet. A sending device constructs QUIC packets that include cleartext metadata, such as PDU Set markings, PDU Set importance, and/or dynamic traffic characteristics, such as time to next burst (TTNB), idle period, and/or burst size indications. This architectural enhancement may enable authorized network entities, such as User Plane Functions (UPFs) and base stations, to extract pertinent traffic information without possessing the keys required to decrypt the actual media payload.

Implementing these techniques may allow the network to perform cross-layer optimizations that improve media experience and device efficiency. Additionally, by exposing application information such as PDU Set info, dynamic traffic characteristics, and end-to-end delay measurements to the network, the techniques of this disclosure may enable network optimization specifically for application traffic. This exposure allows the network to adapt its behavior based on the specific needs and characteristics of the application data being transported, which is not currently possible when such information is hidden within encrypted QUIC packets.

For example, a base station accessing PDU Set importance may intelligently discard low-priority data during high congestion, preserving the integrity of high-priority frames. Simultaneously, exposing dynamic traffic characteristics enables receiving devices to activate low-power modes during signaled idle periods, thereby reducing energy consumption. These techniques may achieve efficient network operation and extended battery life while maintaining the end-to-end security guarantees of the QUIC protocol.

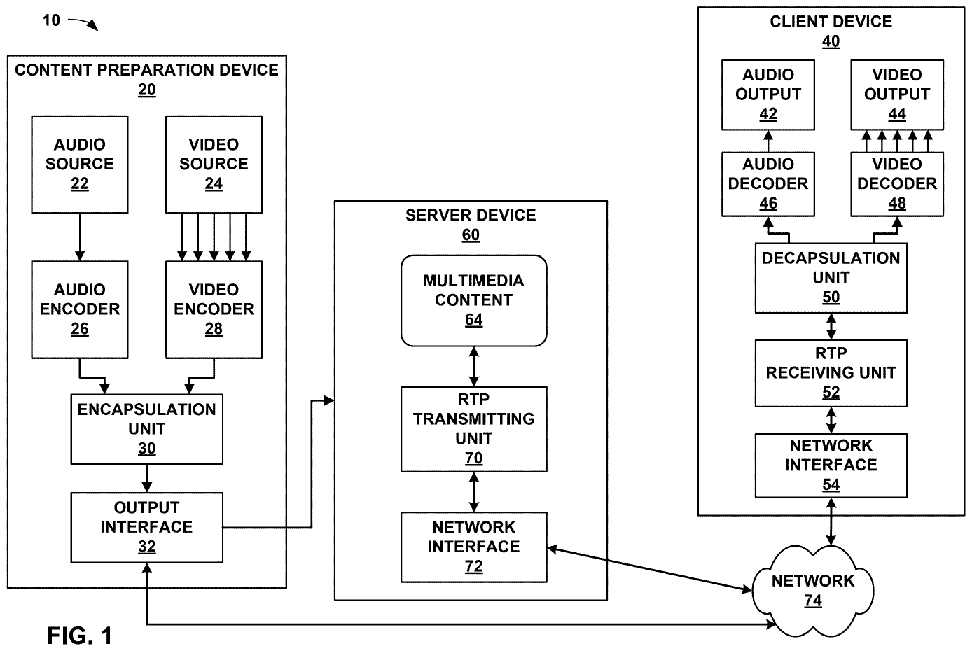

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Server device 60 represents an example of a device for sending media data, and client device 40 represents an example of a device for receiving media data. Server device 60 may construct a QUIC packet including a QUIC header extension including protocol data unit (PDU) Set signaling information. The packet may correspond to a PDU of the PDU Set. The PDU Set signaling information may include one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set. Server device 60 may transmit the QUIC packet to client device 40.

Client device 40 may receive the QUIC packet during a QUIC communication session. Client device 40 may extract the PDU Set signaling information from the QUIC header extension and use the PDU Set signaling information from the QUIC header extension to receive subsequent data of the QUIC communication session. The QUIC header extension may further include dynamic traffic characteristics signaling information. The dynamic traffic characteristics signaling information may include data indicating at least one of a time to next data burst (TTNB) for the QUIC communication session, an idle period value representing a lower bound on a time period during which a traffic source will not send delay-sensitive packets of the QUIC communication session via the network, or a burst size value indicating a size of a current data burst including the packet. Client device 40 may use the dynamic traffic characteristics signaling information to receive the subsequent data of the QUIC communication session.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized into Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and Supplemental Enhancement Information (SEI) NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multiview Video Coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement User Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Although RTP is explained for purposes of example with respect to FIG. 1, other communication protocols may be used instead of RTP. For example, QUIC may be used to exchange media data between server device 60 and client device 40. Therefore, RTP transmitting unit 70 of server device 60 may alternatively be referred to as a “QUIC transmitting unit,” and RTP receiving unit 52 of client device 40 may alternatively be referred to as a “QUIC receiving unit.” These QUIC transmitting/receiving units may use QUIC instead of, or in addition to, RTP when sending/receiving media data.

By using the specific arrangement of signaling PDU Set information and/or dynamic traffic characteristics within unencrypted QUIC header extensions, system 10 may enable network entities of network 74 to access application-layer information without compromising the security of the encrypted packet payload. This visibility may allow for cross-layer optimizations that might otherwise require complex side-channel signaling. For example, network devices of network 74 may use PDU Set importance information to intelligently manage network congestion by prioritizing data of high importance, potentially improving the quality of the media presentation.

Furthermore, the signaling of dynamic traffic characteristics, such as a time to next data burst or an idle period value, may allow receiving devices, such as client device 40, to improve power consumption. By determining the duration of idle periods based on the signaled information, client device 40 may transition receiving circuitry to a low power state during gaps in data transmission. This configuration may effectively reduce power usage without degrading reception performance, while avoiding the latency and complexity associated with establishing separate secure tunnels for conveying such metadata.

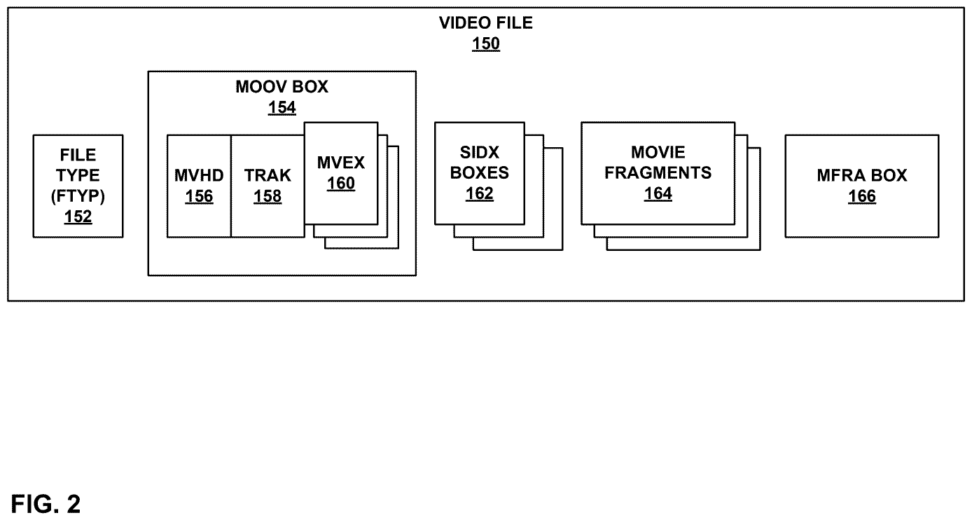

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

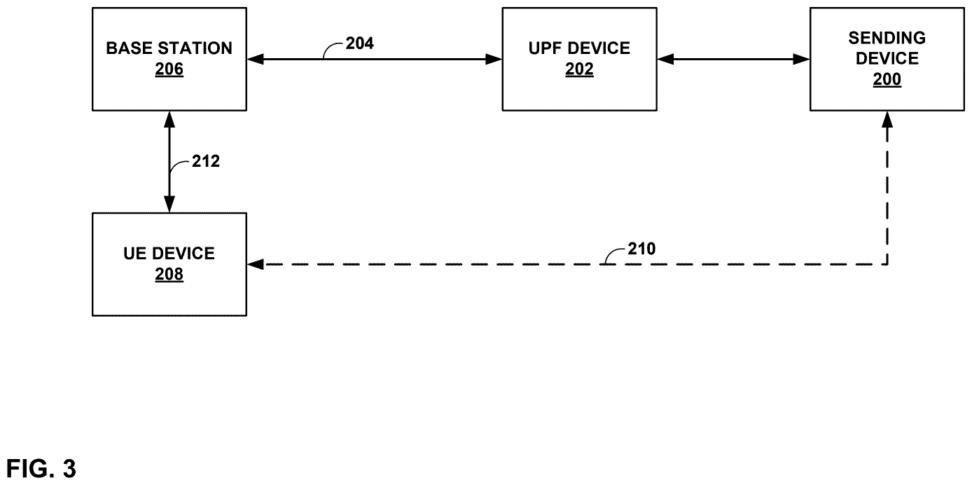

FIG. 3 is a block diagram illustrating an example set of network devices that may perform various aspects of the techniques of this disclosure. The example of FIG. 3 depicts sending device 200, user plane function (UPF) device 202, base station 206, and user equipment (UE) device 208. Sending device 200 may correspond to server device 60 and/or content preparation device 20 of FIG. 1. UE device 208 may correspond to client device 40 of FIG. 1.

Sending device 200 (e.g., an application server (AS) device) may obtain video data to be sent to UE device 208 via communication session 210. To send the video data to UE device 208, sending device 200 may encode the video data (or receive encoded video data from an encoding device, not shown in FIG. 3). Sending device 200 may encapsulate packets including encoded video data (e.g., encoded slices of frames of video data) to form QUIC packets. Sending device 200 may add a QUIC header extension to the QUIC packets, per techniques of this disclosure. The QUIC header extension may include, for example, data representing an idle period indicating a lower bound on a time between a time of transmission of a current QUIC packet and a time of transmission of a subsequent QUIC packet. As the QUIC packets are formed, sending device 200 may send the QUIC packets to UE device 208 via a network including UPF device 202. Although not shown in FIG. 3, there may be additional network devices between sending device 200 and UPF device 202, e.g., various network routing devices, gateways, bridges, switches, or the like.

Sending device 200 may construct a QUIC packet including a QUIC header extension including, for example, PDU Set signaling information, dynamic traffic characteristics (e.g., a TTNB value, an idle period, and/or a burst size value), or data indicating a time at which the QUIC packet was sent. The PDU Set signaling information may include one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set. The dynamic traffic characteristics may include data indicating a time to next data burst (TTNB) for the QUIC communication session, an idle period value representing a lower bound on a time period during which a traffic source will not send delay-sensitive packets, or a burst size value indicating a size of a current data burst. Sending device 200 may send the QUIC packet at a first time (T1), and the QUIC header extension may include data representative of T1.

UPF device 202 may receive the QUIC packets from sending device 200 and form General Packet Radio Service (GPRS) Tunneling Protocol User Plane (GTP-U)tunneled packets. For example, UPF device 202 may encapsulate the QUIC packets with respective GTP-U headers. Per techniques of this disclosure, UPF device 202 may extract the application layer information, e.g., lower bound on the time value, from the QUIC header extensions of the QUIC packets and timestamps indicating times at which the QUIC packets were transmitted by sending device 200, e.g., from respective QUIC header extensions. UPF device 202 may also compare differences between the timestamps to differences between times of reception of the packets to measure network jitter. UPF device 202 may then form the GTP-U headers to include data representing the application layer information, such as a modified idle period time according to the signaled lower bound on the time values and the network jitter. UPF device 202 may send the GTP-U packets to base station 206 via network tunnel 204. Network tunnel 204 may include other network devices, such as network routing devices, configured to forward the GTP-U packets along network tunnel 204 to base station 206.

UPF device 202 may encapsulate the QUIC packet with a GTP-U tunnel header to form a GTP-U tunneled packet and send the GTP-U tunneled packet to base station 206. UPF device 202 may extract the unencrypted data of the QUIC header extension and include this data in the GTP-U tunnel header of the GTP-U tunneled packet. For example, UPF device 202 may extract the PDU Set signaling information from the QUIC header extension and add data representing the PDU Set signaling information to the GTP-U header.

Base station 206 may receive the GTP-U packets and decapsulate the GTP-U packets to reproduce the QUIC packets. Base station 206 may allocate resources to reception of the GTP-U packets based on the modified idle time period. Base station 206 may use the GTP-U tunnel header information (including the data corresponding to the data of the QUIC header extension data) to allocate resources for receiving subsequent packets of the QUIC communication session and/or configure UE device 208 to switch between a reception mode and a low power mode (e.g., to receive packets of the QUIC communication session in the reception mode and to enter the low power mode when no packets are to be sent for the QUIC communication session). Base station 206 may also determine whether to drop PDUs of the PDU Set based on an importance of the PDU Set and a current amount of network congestion. Base station 206 may then send the QUIC packets to UE device 208 via radio access network (RAN) connection 212.

UE device 208 may receive the QUIC packet during the QUIC communication session, extract the PDU Set signaling information and dynamic traffic characteristics, and use such information to receive subsequent data. UE device 208 may receive the QUIC packet at a second time (T2) and send, at a third time (T3), a second QUIC packet including a second QUIC header extension including data representative of T1, T2, and T3, for delay measurement back to sending device 200. Thus, sending device 200 may use this data to measure round trip delay between sending device 200 and UE device 208, to better estimate idle periods or other times during which UE device 208 will not receive data as part of communication session 210.

By encapsulating the QUIC packet with the GTP-U header including the extracted PDU Set signaling information, UPF device 202 may enable base station 206 to perform intelligent traffic management without compromising security of the encrypted QUIC payload. For instance, during periods of high network congestion, base station 206 may use the PDU Set importance information of the GTP-U header to selectively discard entire PDU Sets having lower importance. This selective discarding may prevent transmission of partial or less important data otherwise destined for discard by UE device 208, thereby preserving radio resources for high-priority media data and potentially improving media presentation quality.

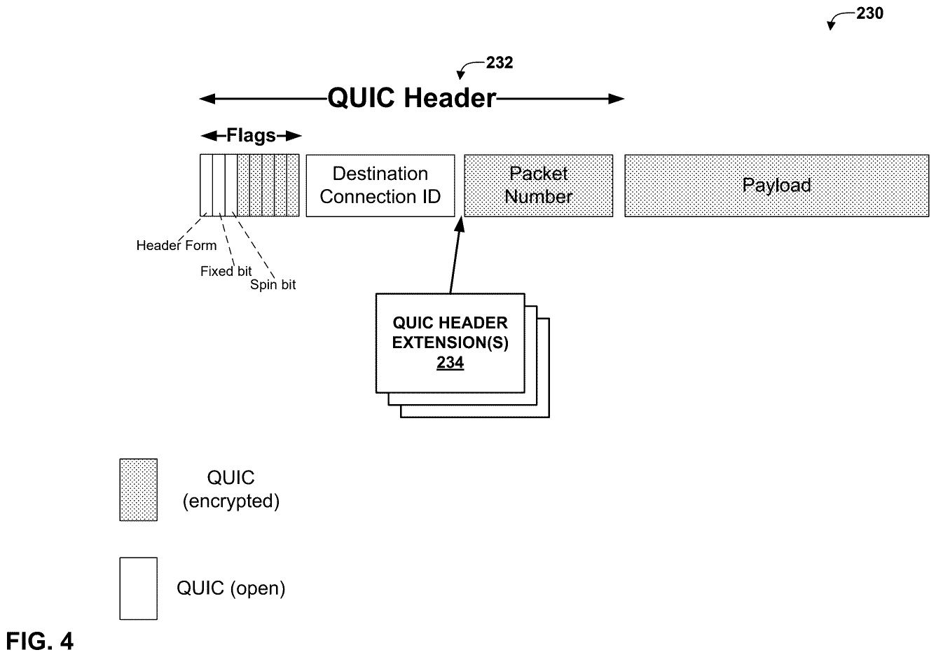

Furthermore, by signaling dynamic traffic characteristics such as the time to next data burst or the idle period value within the unencrypted QUIC header extension, sending device 200 may allow UE device 208 to improve power consumption. UE device 208 may transition to a low-power mode during the signaled idle periods, rather than maintaining a high-power reception state while waiting for subsequent data. This direct signaling within the packet header may reduce latency and complexity associated with establishing separate secure tunnels for conveying such traffic characteristics, potentially resulting in more responsive and power-efficient media delivery. 72.81. FIG. 4 is a conceptual diagram illustrating an example QUIC packet. This packet may be referred to as a “1-RTT QUIC packet.” As shown in FIG. 4, QUIC packet 230 includes unencrypted data (labeled “QUIC (open)” and encrypted data (labeled “QUIC (encrypted)”). As shown in FIG. 4, QUIC header 232 for QUIC packet 230 includes both encrypted and unencrypted data. In QUIC header 232, only part of the flags and the Destination Connection ID are unencrypted, as shown in FIG. 4. The flags include only 3 unencrypted bits in a 1-RTT packet format: Header Form (1)=0; Fixed Bit (1)=1; and Spin Bit (1). The spin bit need not be encrypted, because it has been determined that the spin bit does not leak any information to the network.

Per the techniques of this disclosure, one or more QUIC header extensions may be added to the QUIC packet of FIG. 4, as shown in the example of FIG. 4. Such QUIC header extensions may include unencrypted application layer information that may improve cross-layer efficiency if exposed to the network, e.g., PDU Set information. The QUIC header itself may include data indicating the presence of the QUIC header extensions. For example, the QUIC header may include a QUIC version number, where the QUIC version number indicates whether and/or how many QUIC header extensions are present. Additionally or alternatively, the QUIC header may include a dedicated indicator that indicates whether one or more QUIC header extensions are included. For example, the dedicated indicator may be one of two reserved bits in the 1-RTT packet header.

A QUIC packet may carry one or more header extensions (e.g., extension elements). Each header extension may include a header and header extension data. The header may include an extension identifier that identifies the type of the header extension in a QUIC connection and an extension length indicating the length of the header extension, e.g., in bytes or other relevant size units (bits, words, etc.) The header extension data may include data or metadata to be communicated to the network transporting the QUIC packet. Multiple extension formats may be used, e.g., a one-byte format including the extension ID and extension length together in one-byte, or a two-byte format including the extension ID and extension length together in two-bytes.

In some examples, all QUIC header extensions are unencrypted. An application or device receiving the QUIC header extension may determine whether to use unencrypted QUIC header extension information, based on its implementation. In some examples, the QUIC packet header indicates which of the QUIC header extensions are encrypted or not encrypted, e.g., using a bitmap. For example, the bitmap may be an array of bits each corresponding to one of the QUIC header extensions, where a value of 1 for the bit indicates that the QUIC header extension is encrypted and a value of 0 for the bit indicates that the QUIC header extension is unencrypted. In some examples, the QUIC header extension(s) may be ignored by an endpoint that does not support the QUIC header extension(s), and does not change the meaning of the conventional QUIC header fields.

In some examples, a QUIC packet with one or more header extensions may have a format similar to the following format:

```
1-RTT Packet {
  Header Form (1) = 0,
  Fixed Bit (1) = 1,
  Spin Bit (1),
  Reserved Bits (2) = 10,
  Key Phase (1),
  Packet Number Length (2),
  Destination Connection ID (0 .. 160),
  Packet Number (8 .. 32),
  Extension ID (4) = 1,
  Extension Length (4) = 12,
  Extension data (96),
  Extension ID (4) = 2,
  Extension Length (4) = 4,
  Extension data (32),
  Packet Payload (8 ..),
}
```

In this example, the format represents a QUIC packet having two QUIC header extensions, indicated by respective extension ID, extension length, and extension data fields. The first QUIC header extension includes an extension ID value of 1 (represented by four bits), an extension length value of 12 (indicating that the extension data field has 12 bytes, i.e., 96 bits) and an extension data field of 96 bits of data. The second QUIC header extension includes an extension ID value of 2, an extension length value of 4 (indicating that the extension data field has 4 bytes, i.e., 32 bits), and an extension data field of 32 bits of data. In the format above, a field is represented by the field name, followed by a value in parentheses (indicating a number of bits for that field), and an optional assigned value for the field indicated by an equals sign followed by the value.

Negotiation of the use of QUIC header extensions may be performed between two endpoint devices, such as between a UE device (e.g., UE device 208 of FIG. 3) and an AS device (e.g., sending device 200 of FIG. 3). In some examples, this negotiation may be performed in-band, where negotiation frames are exchanged during session setup. Negotiation data may be carried in some QUIC packets (e.g., initial packet, handshake packet(s), and/or 1-RTT packet(s)) during the handshake phase. In some examples, two frames are defined and sent as part of the normal payload of the initial packets. The two frames may include a “QUIC header extension request” frame, which carries the header extension IDs and respective definitions of the extensions. The QUIC header extension request frame may be included in the initial packet from the client to the server, where the definition may be indicated by a URL, Uniform Resource Identifier (URI), or URN (which may be registered with IANA). The two frames may also include a “QUIC header extension response” frame, which confirms support for the types of header extensions through indication of the respective header extension IDs, and may be included in the initial packet from the server to the client. Although the two initial packets are encrypted, this encryption generally uses a key derived from a cleartext connection ID and a well-known salt number, such that intermediate routers (e.g., UPF device 202) can inspect the packet(s) and decode the payload (carrying the request/response frames) to determine the meaning of the header extensions.

Alternatively, the two frames may be as indicated above, but the frames need not be encrypted in the QUIC packets (e.g., initial packet, handshake packet, and 1-RTT packet). This may simplify the complexity at intermediate routers (e.g., UPF device 202 of FIG. 3), but may change encryption procedures at QUIC endpoints (e.g., UE device 208 and sending device 200).

By sending the negotiation request and response frames in an unencrypted format within the QUIC packets (e.g., Initial, Handshake, or 1-RTT packets), the techniques of this disclosure may simplify the complexity required at intermediate routers (e.g., UPF device 202). Specifically, the intermediate routers do not need to perform decryption operations or key derivation to inspect the negotiation parameters, thereby reducing the computational load on the network infrastructure while maintaining visibility into the negotiated header extensions.

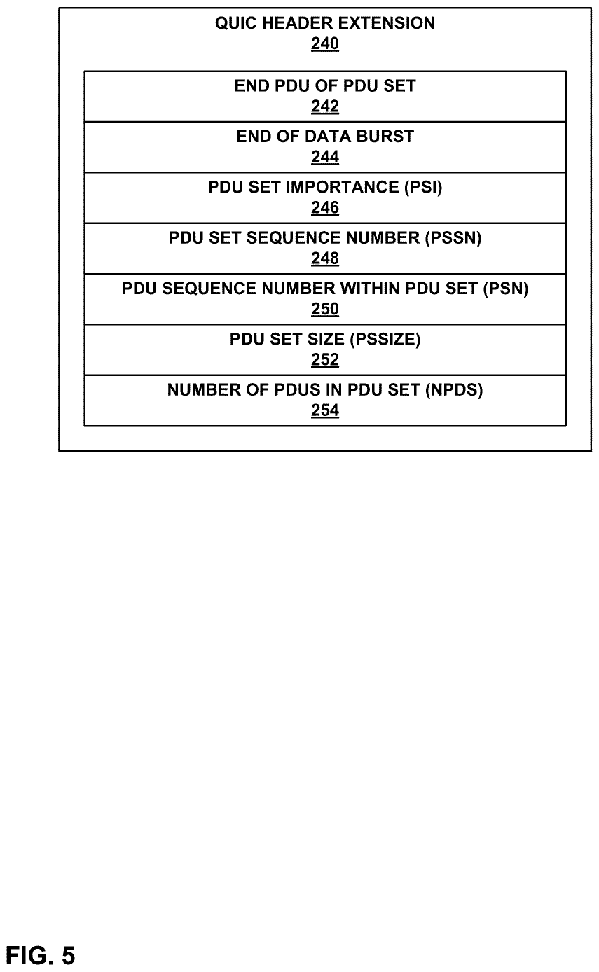

FIG. 5 is a block diagram illustrating an example QUIC header extension 240 including PDU Set information per techniques of this disclosure. In this example, QUIC header extension 240 includes end PDU of PDU Set element 242, end of data burst element 244, PDU Set importance (PSI) element 246, PDU Set sequence number (PSSN) element 248, PDU sequence number within PDU Set (PSN) element 250, PDU Set size (PSSize) element 252, and number of PDUs in PDU Set (NPDS) element 254.

End PDU of PDU Set element 242 may be a single bit having a value of 1 for the last PDU of the PDU Set or a value of 0 for all other PDUs of the PDU Set. In this manner, the value of end PDU of PDU Set element 242 may indicate whether the corresponding PDU is the last PDU of the PDU Set.

End of data burst element 244 may be a single bit having a value of 1 for the last PDU of a data burst or a value of 0 for other PDUs of the data burst. In this manner, the value of end of data burst element 244 may indicate whether the corresponding PDU is the last PDU of the current data burst.

PDU Set importance element 246 may be a four-bit field having a value indicating a relative importance of the current PDU Set relative to other PDU Sets. A lower value may indicate a higher importance for the PDU Set, with 1 indicating the highest importance and 15 being the lowest importance, in this example. When the QUIC sender (e.g., sending device 200) cannot determine an importance, the QUIC sender may set the value of PDU Set importance element 246 to 0.

PSSN element 248 may be a ten-bit field having a value representing a sequence number of the PDU Set to which the current PDU belongs.

PSN element 250 may be a six-bit field having a value indicating a sequence number of the current PDU within the current PDU Set. The PSN may be set to 0 for the ordinal first PDU in the PDU Set and incremented monotonically for each PDU in the PDU Set in order of transmission from the sender, e.g., sending device 200.

PSSize element 252 may be a 24-bit field having a value indicating a total size of all PDUs of the PDU Set to which the current PDU belongs.

NPDS element 254 may be a 16-bit field having a value indicating a total number of PDUs within the PDU Set, which may indicate the total number of PDUs belonging to the same PDU Set.

By using the specific arrangement of data elements within QUIC header extension 240 in this example, network devices may facilitate cross-layer optimization in a network environment where payload encryption is used. For example, exposing PDU Set importance element 246 and end of data burst element 244 in an unencrypted format may allow network entities to make intelligent scheduling decisions, such as discarding low-priority PDU Sets or configuring discontinuous reception cycles, without accessing the encrypted packet payloads. This configuration may effectively balance the need for end-to-end security with the requirements for efficient network traffic management, potentially reducing latency and power consumption compared to solutions relying on deep packet inspection or out-of-band signaling.

Furthermore, because the dynamic traffic characteristics (e.g., TTNB, idle period, burst size) are explicitly signaled in the unencrypted QUIC header extension, intermediate routing devices (e.g., UPF device 202) can access this information immediately upon packet reception. This may avoid the processing delay and computational overhead associated with deep packet inspection or traffic pattern analysis, where the network entity would otherwise need to observe the traffic flow for a period (e.g., several milliseconds) to infer these characteristics.

In some examples, a QUIC packet with one or more header extensions including PDU Set and/or burst information may have a format similar to the following format:

```
1-RTT Packet {
  Header Form (1) = 0,
  Fixed Bit (1) = 1,
  Spin Bit (1),
  Reserved Bits (2) = 10,
  Key Phase (1),
  Packet Number Length (2),
  Destination Connection ID (0 .. 160),
  Packet Number (8 .. 32),
  Extension ID (4) = 1,
  Extension Length (4) = 8,
  End PDU of PDU Set (1) = 0,
  End of Data Burst (1) = 0,
  Reserved bits (2),
  PSI (4) = 5,
  PSSN (10),
  PSN (6),
  PSSize (24),
  NPDS (16),
  Packet Payload (8 ..),
}
```

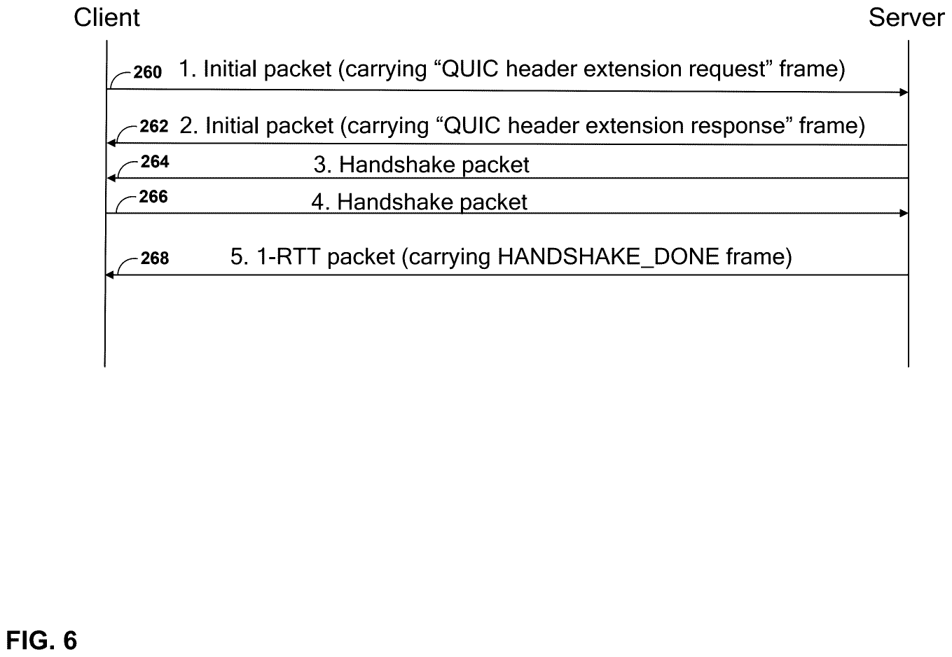

FIG. 6 is a call flow diagram illustrating an example method for negotiating use of QUIC header extensions per techniques of this disclosure. In this example, initially, a client device (e.g., UE device 208 of FIG. 3 or client device 40 of FIG. 1) sends an initial QUIC packet carrying a “QUIC header extension request” frame as discussed above to a server device (e.g., sending device 200 of FIG. 3 or server device 60 of FIG. 1) (260). In particular, the QUIC header extension request frame may request support for PDU Set marking, dynamic characteristics, and/or latency measurement data, per techniques of this disclosure. The request may indicate a header extension ID value and definition of the header type, such as a URN “urn:3gpp:quic-pdu-set-marking:rel-20”, URI, URL, or an index value.

The server device then responds with an initial packet carrying a “QUIC header extension response” frame (262) as discussed above. In particular, the server device may respond with a QUIC header extension response indicating support for PDU Set marking per techniques of this disclosure. For example, the response may contain the extension ID supported by the QUIC server if the server supports PDU Set marking per these techniques. The server and client devices then exchange handshake packets (264, 266). The server device then sends a 1-RTT packet carrying a “HANDSHAKE_DONE” frame (268). This may result in QUIC session establishment, and the server device can proceed to send QUIC packets including QUIC header extensions according to the session negotiation, per the techniques of this disclosure.

The request and response may be sent in two dedicated QUIC frames, e.g., as discussed above.

When the initial packets (client to server, and server to client) are used, the request and response may, or may not, be encrypted. In general, even if the Initial packets are encrypted, a network entity may still be capable of decrypting the Initial packets, due to the encryption scheme. When other packets (Handshake packets, 1-RTT packet) are used, the request and response need not be encrypted, e.g., to provide visibility to the network entity.

In some examples, QUIC header extension negotiation may be performed out of band, e.g., using SDP signaling. SDP Offer and Answer messages may allow the endpoints to negotiate the use of the QUIC header extensions. A first endpoint may send an SDP Offer message containing data indicating supported QUIC header extensions. A second endpoint may then reply with an SDP Answer message containing data indicating its own supported QUIC header extensions, e.g., as a subset of the supported QUIC header extensions of the first endpoint. The two endpoints may then use any of the QUIC header extensions indicated in the SDP Answer message.

The SDP Offer and Answer messages may carry an SDP attribute “quicextmap” including an extension name (e.g., URI, URN, or URL) and extension attributes (e.g., optional configurations). The Augmented Backus-Naur Form (ABNF) syntax may be as follows:

```
Name: quicextmap
Value: quicextmap-value
Syntax:
  quicextmap-value = mapentry SP extensionname [SP extensionattributes]
  mapentry = “quicextmap:” 1*5DIGIT [“/” direction]
  extensionname = URI
  extensionattributes = byte-string
  direction = “sendonly” / “recvonly” / “sendrecv” / “inactive”
  URI = <Defined in RFC 3986>
  byte-string = <a byte string, defined in RFC 4566>
  SP = <the “space” ASCII character>
  DIGIT = <numbers 0 through 9>
```

The extension name may be “urn:3gpp:quic-pdu-set-marking:rel-20.” The extension may include an indication of whether optional fields are present, e.g., whether the NPDS element is present and/or whether the PSSize element is present.

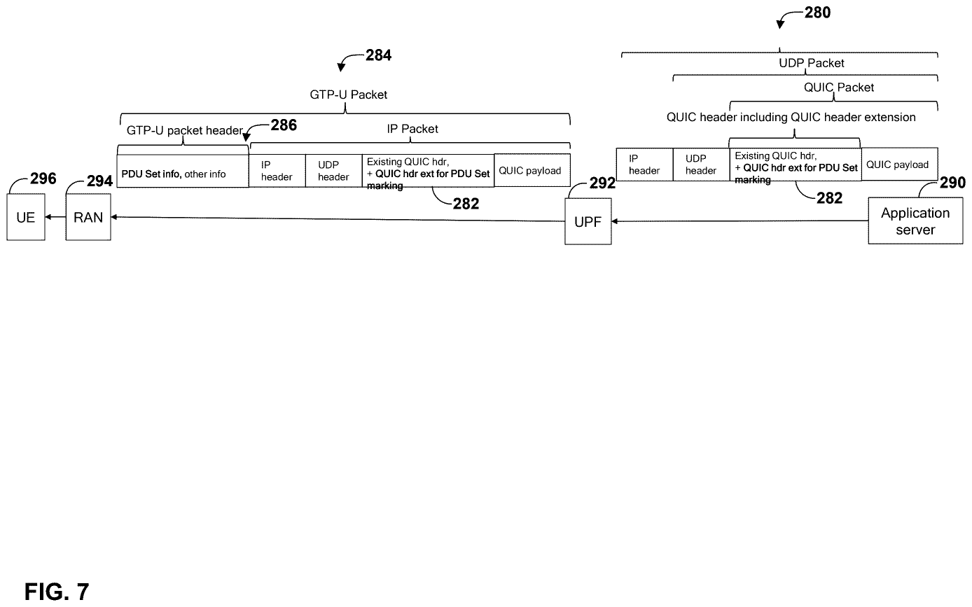

FIG. 7 is a conceptual diagram illustrating an example of use of QUIC packets including QUIC header extensions including PDU Set marking information per techniques of this disclosure. In some examples, a protocol description may include data indicating the protocol (QUIC), the type of the QUIC header extension being for PDU Set marking (PDU_SET_MARKING), and a QUIC header extension identifier, e.g., 3. An application function (AF) device may extract the protocol description and send data representing the protocol description to the policy and charging function (PCF) device. The PCF device may generate the policy and charging control (PCC) rules and configure a session management function (SMF) device accordingly. The SMF device may configure UPF device 292 on how to identify QUIC packets with PDU Set marking.

UPF device 292 may identify (based on the protocol description) QUIC packets, such as QUIC packet 280, with QUIC header extension 282 including PDU Set marking data. UPF device 292 may then extract the PDU Set marking information from the QUIC header extension 282. UPF device 292 may further encapsulate each QUIC packet into a GTP-U packet, such as GTP-U packet 284, and add the extracted PDU Set marking information and/or burst information in the GTP-U packet header, such as GTP-U packet header 286. A base station of radio access network (RAN) 294 may use the PDU Set information extracted from GTP-U packet header 286 for scheduling, e.g., to drop an entire PDU Set with a high PSI value (low importance level) among PDU Sets being received during a period of high network congestion, or otherwise adapt behavior of UE device 296.

In another example, in addition to or in the alternative to PDU Set signaling information, a QUIC packet may include a QUIC header extension including dynamic traffic characteristics data. For example, the dynamic traffic characteristics data may include data burst information for data bursts sent via a network.

The dynamic traffic characteristics data may include, for example, a time to next data burst (TTNB) value. The TTNB value may be expressed as an integer value in units of 1/10 milliseconds. In some examples, the TTNB value may indicate a time from an ordinal last packet of a current data burst including the packet that signals the TTNB value in a QUIC header extension to an ordinal first packet of a next data burst for the QUIC communication session. In some examples, the TTNB value may indicate a time period during which a traffic source (e.g., sending device 200) does not send delay-sensitive packets via the network. Delay-sensitive packets may include packets including media data of a media communication session. The base station of RAN 294 may configure UE device 296 to enter a low power mode following reception of an ordinal last packet of a current data burst, and to reenter a reception mode following the time indicated by the TTNB value.

Additionally or alternatively, the dynamic traffic characteristics data may include data for an idle period value. The idle period value may be expressed as an integer value in units of 1/10 milliseconds and represent a lower bound on the TTNB value corresponding to the time from the last packet of the current data burst to the first packet of the next data burst (e.g., the first alternative definition discussed above). The base station of RAN 294 may configure UE device 296 to enter a low power mode during the idle period, and to reenter a reception mode following the idle period.

Additionally or alternatively, the dynamic traffic characteristics data may include burst size data. The burst size data may indicate a size of a current data burst including the packet that includes the QUIC header extension. The burst size data may indicate a size of a current data burst including the packet that includes the QUIC header extension. The burst size data may be represented as an integer value in units of bytes. This indication may be carried by an ordinal first packet of a current data burst (i.e., the data burst including the ordinal first packet of that data burst). The base station of RAN 294 may configure UE device 296 to enter a low power mode following reception of a cumulative amount of data equal to the size of the current data burst.

Additionally or alternatively, the dynamic traffic characteristics data may include indications of whether a TTNB value, an idle period value, and/or a burst size value is valid or not.

In some examples, for any of the TTNB, idle period, or burst value data, if the corresponding value is unknown at the time of transmission/indication, the value may be set to all ‘1’s. For example, for a 16-bit field (e.g., TTNB or idle period), the value may be 0xffff, and for a 24-bit field (e.g., burst size), the value may be 0xffffff.

An intermediate routing device, such as UPF device 292, may determine the values for TTNB, idle period, and/or data burst size a few milliseconds after a packet has been transmitted and received through observation of the traffic pattern, regardless of whether this information is carried in the QUIC packet header. Therefore, explicitly signaling this data in an unencrypted portion of the QUIC packet header does not expose any information that the network does not or will not be able to determine. As such, exposure of this information explicitly per these techniques does not result in exposure of sensitive information that should not be revealed. Consequently, explicit exposure of this information in clear text (such as in an unencrypted QUIC header extension) may avoid exposure of sensitive information, while also reducing latency with respect to use of this information to improve transmission times for QUIC packets.

Negotiation for the use of a QUIC header extension that signals dynamic traffic characteristic data may generally be as discussed above with respect to negotiation for the use of a QUIC header extension that signals PDU Set information, with certain modifications as discussed below. In some examples, a definition for a QUIC header extension type may be signaled in-band, e.g., using a URN such as “urn:dynamic-traffic-characteristics:rel-20,” a URI, a URL, or an index value, along with the presence of one or more of, e.g., TTNB, idle period, and/or data burst information. Additionally or alternatively, such negotiation may be performed out-of-band, e.g., using an SDP Offer and/or an SDP Answer message. The extension name may be “urn:3gpp:dynamic-traffic-characteristics:rel-20.” The network operation may be as discussed above, except that the QUIC packet would have a different header extension type for the dynamic traffic characteristics data.

Examples of QUIC 1-RTT packets including dynamic traffic characteristic data include:

```
1-RTT Packet {
  Header Form (1) = 0,
  Fixed Bit (1) = 1,
  Spin Bit (1) = 1,
  Reserved Bits (2),
  Key Phase (1),
  Packet Number Length (2),
  Destination Connection ID (0..160),
  Packet Number (8..32),
  Validity Flags (8),
  TTNB (16),
  Burst Size (24),
  Packet Payload (8 ..),
}
1-RTT Packet {
  Header Form (1) = 0,
  Fixed Bit (1) = 1,
  Spin Bit (1) = 1,
  Reserved Bits (2),
  Key Phase (1),
  Packet Number Length (2),
  Destination Connection ID (0..160),
  Packet Number (8..32),
  Idle Period (16),
  Burst Size (24),
  Packet Payload (8 ..),
}
```

A protocol description for dynamic traffic characteristics data may include a protocol indication (“QUIC”), a type of the QUIC header extension being for dynamic traffic characteristics, e.g., PDU_SET_DYNAMIC_TRAFFIC_CHARACTERISTICS, and/or a QUIC header extension ID, e.g., 2. The protocol description may be extracted by the AF device, which sends the protocol description to the PCF device. The PCF device may generate PCC rules and configure the SMF device. The SMF device may configure the UPF device on how to identify QUIC packets including dynamic traffic characteristics data.

RFC 9000 also defines a QUIC PING frame type. A sending device (e.g., sending device 200) may send a QUIC packet containing a QUIC PING frame to a receiving device (e.g., UE device 208). In response to the QUIC PING frame, the receiving device may send an acknowledgement of having received the QUIC PING frame. The QUIC PING frame may therefore be used to measure a round-trip time (RTT), but not one-way delay.

A TIMESTAMP frame is used, in some examples, to measure one-way delay. However, use of the TIMESTAMP frame in this way relies on an assumption that one-way delays in both directions (uplink and downlink) are symmetrical. This disclosure recognizes that delay in both directions is not always symmetrical in all cases. Furthermore, if delay were symmetrical, the QUIC PING frame would be sufficient to measure one-way delay, because the RTT delay could be measured then divided in half.

Accordingly, this disclosure describes techniques that may be used to measure both RTT and one-way delay without the assumption that one-way delay is equal in both directions. These techniques may also be used to measure processing delay.

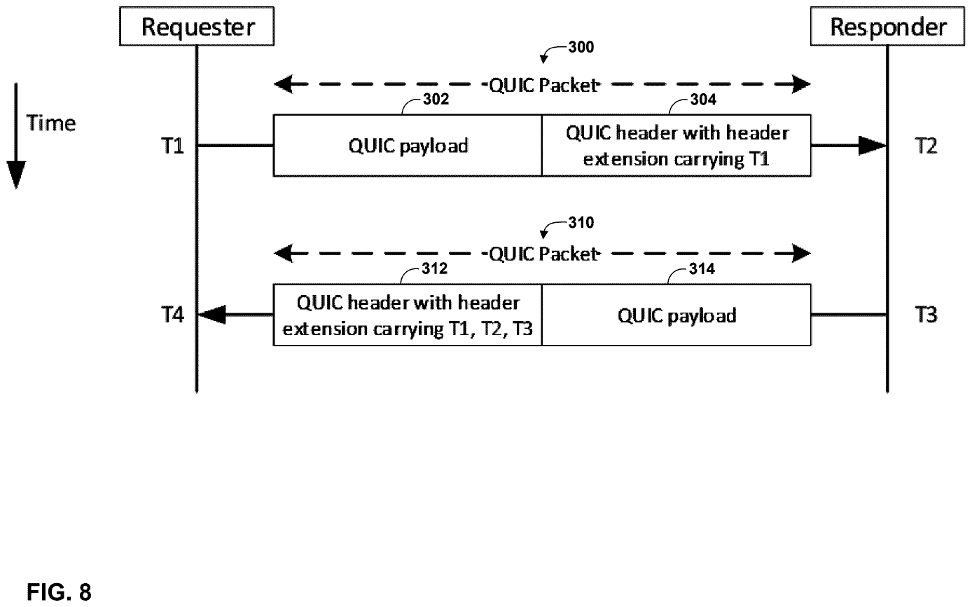

FIG. 8 is a call flow diagram illustrating an example method for measuring end-to-end delay per techniques of this disclosure. For example, the method of FIG. 8 may be used to measure delay between sending device 200 and UE device 208 of FIG. 3. The end-to-end delay measurement may be performed using two messages, each carrying a type of header extension, as shown in FIG. 8. For example, a requesting device (e.g., sending device 200) may send QUIC packet 300 including QUIC header extension 304 carrying data indicating time T1 at which the QUIC packet was sent, as well as QUIC payload 302.

A responding device (e.g., UE device 208) may determine that QUIC packet 300 was received at time T2. At time T3, the receiving device may send QUIC packet 310 including QUIC payload 314 and QUIC header extension 312 that includes data representative of each of times T1, T2, and T3.

Thus, per the example method of FIG. 8, a requesting device sends a QUIC packet including a QUIC header extension carrying an originate timestamp (e.g., T1, the time when the requesting device transmits the QUIC packet toward the responding device).

The responding device replies with a QUIC packet having a header including a QUIC header extension carrying data representing the originate timestamp (T1), a receive timestamp (T2, the time when the responding device received the QUIC/RTP packet that carried the originate timestamp T1), and a transmit timestamp (T3, the time when the responding device transmits the QUIC/RTP packet that carries the originate timestamp T1, the receive timestamp T2, and the transmit timestamp T3).

The requesting device may then generate a destination timestamp (T4) upon receiving the reply from the responding device.

Each timestamp (T1, T2, T3, and T4) may follow a truncated network time protocol (NTP) timestamp format, e.g., as defined in Mills et al., “Network Time Protocol Version 4: Protocol and Algorithms Specification,” Internet Engineering Task Force (IETF), RFC 5905, June 2010. For example, the timestamps may be represented by 24 bits, taken from the six least significant bits (LSBs) of the integer part and the 18 most significant bits (MSBs) of the fractional part of the NTP timestamp format.

The QUIC header extension type for the QUIC packet sent by the requesting device may be “urn:3gpp:quic-delay-measurement-request:rel-21.” The QUIC header extension type for the QUIC packet sent in response by the responding device may be “urn:3gpp:quic-delay-measurement-response:rel-21.”

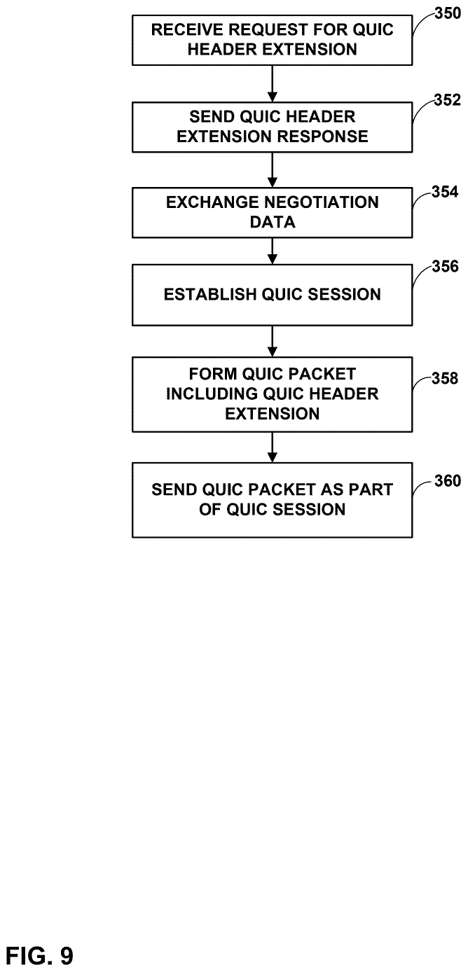

FIG. 9 is a flowchart illustrating an example method of constructing and sending a QUIC packet including a QUIC header extension per techniques of this disclosure. Sending device 200 (FIG. 3), server device 60 (FIG. 1), or AS device 290 (FIG. 7) may perform the method of FIG. 9. Initially, sending device 200 may negotiate the use of QUIC header extensions with a client device, such as UE device 208. In this example, sending device 200 receives a request for a QUIC header extension (350) from UE device 208. For example, sending device 200 may receive an initial QUIC packet including a QUIC header extension request frame. This frame may include a header extension identifier (ID) and a definition of the extension type (e.g., via a URI).

In response, sending device 200 may send a QUIC header extension response (352) to UE device 208. For instance, sending device 200 may send an initial QUIC packet including a response frame confirming support for the requested extension ID. Sending device 200 may also exchange negotiation data (354) with UE device 208. This exchange may include sending and/or receiving transport parameters indicating supported and accepted header extensions during a handshake phase. Alternatively, sending device 200 may perform negotiation out-of-band, such as by sending a Session Description Protocol (SDP) offer message or receiving an SDP answer message containing a ‘quicextmap’attribute.

Sending device 200 establishes the QUIC communication session (356), for example, after completing a handshake and sending a 1-RTT packet carrying a HANDSHAKE_DONE frame. Subsequently, sending device 200 forms a QUIC packet including the QUIC header extension (358). Sending device 200 constructs the QUIC packet to include an unencrypted QUIC header extension separate from the flags and connection ID. Sending device 200 may position the QUIC header extension after a packet number of the QUIC packet and before payload data, e.g., within an unencrypted portion of the QUIC packet header. Sending device 200 may include PDU Set signaling information in the QUIC header extension, such as any or all of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set. Additionally or alternatively, sending device 200 may include dynamic traffic characteristics signaling information in the QUIC header extension. Additionally or alternatively, sending device 200 may include a time (T1) at which the QUIC packet was constructed in the QUIC header extension.

Finally, sending device 200 sends the QUIC packet as part of the QUIC session (360). Intermediate devices, such as UPF device 202, may access the unencrypted header extension to facilitate cross-layer optimization, while the payload remains encrypted.

In this manner, the method of FIG. 9 represents an example of a method of transmitting data via a network, including: constructing, for a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; and sending the QUIC packet to a client device.

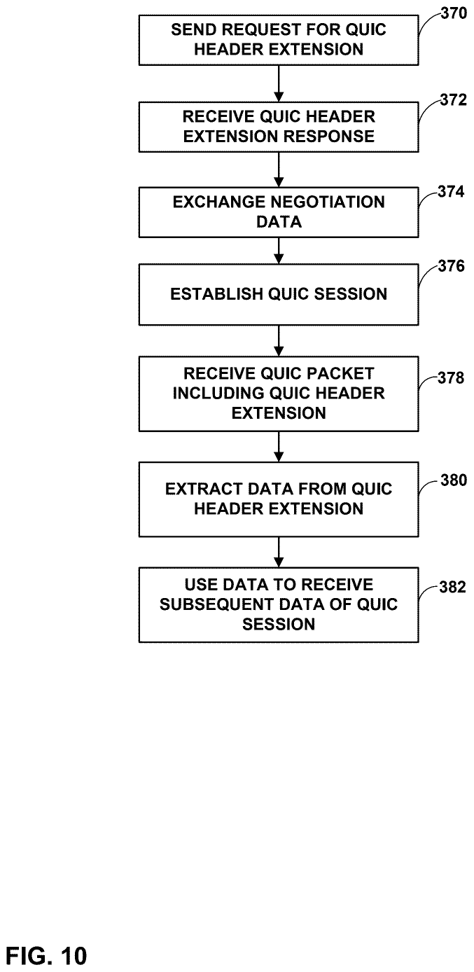

FIG. 10 is a flowchart illustrating an example method of receiving a QUIC packet including a QUIC header extension and using data of the QUIC header extension to receive data of a QUIC communication session per techniques of this disclosure. The method of FIG. 10 may be performed by a destination device, such as UE device 208 (FIG. 3) or client device 40 (FIG. 1). Alternatively, intermediate devices such as UPF device 202 or base station 206 may perform aspects of the method.

Initially, UE device 208 may send a request for a QUIC header extension to be used during a QUIC communication session (370). This step may occur before receiving a QUIC packet carrying media data. UE device 208 may then receive a QUIC packet including a QUIC header extension response (372) confirming support for the QUIC header extension. UE device 208 may further exchange negotiation data (374) with sending device 200 and thus establish a QUIC communication session (376).

In some examples, the negotiation data is encrypted according to a key derived from a cleartext connection identifier and a predefined salt number, or may be unencrypted. In other examples, exchanging the negotiation data includes sending a Session Description Protocol (SDP) offer message indicating support for the QUIC header extension and receiving an SDP answer message confirming support. The negotiation data may include an SDP attribute “quicextmap” including an extension name and extension attributes.

During the QUIC communication session, UE device 208 receives a QUIC packet including a QUIC header extension (378). The QUIC header extension is unencrypted and is separate from a set of flags and a connection identifier (ID) of the QUIC packet. In some examples, the QUIC header extension follows a packet number of the QUIC packet and precedes payload data of the QUIC packet. UE device 208 may determine that the QUIC packet includes the QUIC header extension according to a QUIC version number for the QUIC packet or according to an indicator value included in a set of reserved bits of a 1-RTT packet header of the QUIC packet.

UE device 208 extracts data from the QUIC header extension (380). The QUIC header extension may include PDU Set signaling information in the QUIC header extension, such as any or all of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set. Additionally or alternatively, the QUIC header extension may include dynamic traffic characteristics signaling information in the QUIC header extension.

Additionally or alternatively, the QUIC header extension may include a time (T1) at which the QUIC packet was sent to UE device 208. In response, the UE device may construct a separate QUIC packet including a QUIC packet header specifying time T1, a time T2 at which the previous QUIC packet was received by UE device 208, and a time T3 at which UE device 208 sends the separate QUIC packet to sending device 200.

UE device 208 uses the data from the received QUIC header extension to receive data of the QUIC communication session (382). For example, UE device 208 may use the data of the QUIC header extension to enter a low-power state for the duration of the idle period. If the method is performed by UPF device 202, using the data may involve encapsulating the QUIC packet to form a GTP-U tunneled packet and adding data representing the extracted data to a GTP-U header. If the method is performed by base station 206, using the data may involve performing scheduling for UE device 208 or adapting behavior of UE device 208 using the data.

In this manner, the method of FIG. 10 represents an example of a method of receiving data via a network, including: receiving, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extracting the PDU Set signaling information from the QUIC header extension; and using the PDU Set signaling information from the QUIC header extension to receive subsequent data of the QUIC communication session.

Various examples of the techniques of this disclosure are summarized in the following clauses:

Clause 1. A method of receiving data via a network, the method comprising: receiving, during a QUIC communication session, a QUIC packet including a QUIC header extension including protocol data unit (PDU) Set signaling information, the packet corresponding to a PDU of the PDU Set; extracting the PDU Set signaling information from the QUIC header extension; and using the PDU Set signaling information from the QUIC header extension to receive subsequent data of the QUIC communication session.

Clause 2. The method of clause 1, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set.

Clause 3. The method of clause 2, wherein the PDU Set signaling information includes the data indicating whether the PDU is the last PDU of the PDU Set, the data indicating whether the PDU is the last PDU of the PDU Set being a single bit value.

Clause 4. The method of any of clauses 2 and 3, wherein the PDU Set signaling information includes the data indicating whether the PDU is the last PDU of the current data burst, the data indicating whether the PDU is the last PDU of the current data burst being a single bit value.

Clause 5. The method of any of clauses 2-4, wherein the PDU Set signaling information includes the PDU Set importance information, the PDU Set importance information indicating a relative importance of the PDU Set relative to other PDU Sets of the QUIC communication session.

Clause 6. The method of clause 5, wherein the PDU Set importance information is a value within a range having a starting value and an ending value, the starting value being below the ending value, the starting value indicating a higher importance than the ending value.

Clause 7. The method of any of clauses 5 and 6, wherein the PDU Set importance information is indicated by a four-bit value.

Clause 8. The method of any of clauses 5-7, wherein a value of zero for the PDU Set importance information indicates that importance is not defined for the PDU Set.

Clause 9. The method of any of clauses 2-8, wherein the PDU Set signaling information includes the PDU Set sequence number, the PDU Set sequence number being a ten-bit value.

Clause 10. The method of any of clauses 2-9, wherein the PDU Set signaling information includes the sequence number for the PDU, the sequence number for the PDU being a six-bit value that monotonically increases for each PDU of the PDU Set.

Clause 11. The method of any of clauses 2-10, wherein the PDU Set signaling information includes the PDU Set size, the PDU Set size being a 24-bit value indicating a total size of all PDUs of the PDU Set.

Clause 12. The method of any of clauses 2-11, wherein the PDU Set signaling information includes the number of PDUs in the PDU Set, the number of PDUs in the PDU Set being a 16-bit value indicating the number of PDUs in the PDU Set.

Clause 13. The method of any of clauses 2-12, wherein the QUIC packet comprises a 1-RTT packet.

Clause 14. The method of any of clauses 1-13, further comprising exchanging negotiation data representing the QUIC header extension before receiving the QUIC packet.

Clause 15. The method of clause 14, wherein exchanging the negotiation data includes receiving an initial QUIC packet including a QUIC header extension request frame including a header extension identifier for the QUIC header extension and a definition of the QUIC header extension.

Clause 16. The method of any of clauses 14 and 15, wherein exchanging the negotiation data includes receiving an initial QUIC packet including a QUIC header extension response frame confirming support for the QUIC header extension.

Clause 17. The method of any of clauses 15 and 16, wherein the negotiation data is encrypted according to a key derived from a cleartext connection identifier and a predefined salt number.

Clause 18. The method of any of clauses 15 and 16, wherein the negotiation data is unencrypted.

Clause 19. The method of any of clauses 1-18, further comprising receiving protocol description data indicating that QUIC protocol applies to the QUIC communication session and how to identify QUIC packets including the PDU Set signaling information.

Clause 20. The method of any of clauses 1-19, wherein the method is performed by a user plane function (UPF) device, the method further comprising: encapsulating the QUIC packet to form a GTP-U tunneled packet; and adding data representing the PDU Set signaling information to a GTP-U header of the GTP-U tunneled packet.

Clause 21. The method of any of clauses 1-19, wherein the method is performed by a base station device, and wherein using the PDU Set signaling data comprises determining whether to drop PDUs of the PDU Set based on an importance of the PDU Set and a current amount of network congestion.

Clause 22. A method of receiving data via a network, the method comprising: receiving, during a QUIC communication session, a QUIC packet including a QUIC header extension including dynamic traffic characteristics signaling information; extracting the dynamic traffic characteristics signaling information from the QUIC header extension; and using the dynamic traffic characteristics signaling information from the QUIC header extension to receive subsequent data of the QUIC communication session.

Clause 23. The method of clause 22, wherein the dynamic traffic characteristics signaling information includes data indicating a time to next data burst (TTNB) for the QUIC communication session.

Clause 24. The method of clause 23, wherein the TTNB comprises a value in a unit of 1/10 milliseconds.

Clause 25. The method of any of clauses 23 and 24, wherein the TTNB indicates a time to next data burst relative to a time for a current data burst including the packet.

Clause 26. The method of any of clauses 23 and 24, wherein the TTNB indicates a time period during which a traffic source will not send delay-sensitive packets of the QUIC communication session via the network.

Clause 27. The method of any of clauses 22-26, wherein the dynamic traffic characteristics signaling information includes an idle period value representing a lower bound on a time period during which a traffic source will not send delay-sensitive packets of the QUIC communication session via the network.

Clause 28. The method of any of clauses 22-27, wherein the dynamic traffic characteristics signaling information includes a burst size value indicating a size of a current data burst including the packet.

Clause 29. The method of any of clauses 22-28, wherein the dynamic traffic characteristics signaling information includes data indicating whether a time to next burst (TTNB) value for the packet is valid.

Clause 30. The method of any of clauses 22-29, wherein the dynamic traffic characteristics signaling information includes data indicating whether an idle period value for the packet is valid.

Clause 31. The method of any of clauses 22-30, wherein the dynamic traffic characteristics signaling information includes data indicating whether a burst size value for a current burst including the packet is valid.

Clause 32. The method of any of clauses 22-31, further comprising receiving negotiation data defining the QUIC header extension.

Clause 33. The method of clause 32, wherein receiving the negotiation data comprises receiving the negotiation data in-band with the QUIC communication session.

Clause 34. The method of clause 32, wherein receiving the negotiation data comprises receiving the negotiation data out-of-band relative to the QUIC communication session.

Clause 35. The method of clause 34, wherein receiving the negotiation data out-of-band comprises receiving the negotiation data in a session description protocol (SDP) offer message or an SDP answer message.

Clause 36. A method of measuring delay in a network, the method comprising: sending, at a first time (T1), a first QUIC packet including a first QUIC header extension including data representative of T1, to a responding device; receiving, at a fourth time (T4), a second QUIC packet including a second QUIC header extension including data representative of T1, a second time (T2) at which the responding device received the first packet, and a third time (T3) at which the responding device sent the second QUIC packet; and calculating delay in the network based on T1, T2, T3, and T4.

Clause 37. A method comprising a combination of the method of any of clauses 1-35 and the method of clause 36:

Clause 38. A method of measuring delay in a network, the method comprising: receiving, at a second time (T2) and from a requesting device, a first QUIC packet including a first QUIC header extension including data representative of a first time (T1) at which the requesting device sent the first QUIC packet; and sending, at a third time (T3) and to the requesting device, a second QUIC packet including a second QUIC header extension including data representative of T1, T2, and T3.

Clause 39. A method comprising a combination of the method of any of clauses 1-37 and the method of clause 38.

Clause 40. The method of any of clauses 36-39, wherein each of T1-T4 conforms to a truncated network time protocol (NTP) format, such that each of T1-T4 is represented by a 24-bit value including six least significant bits (LSBs) of an integer part of a full NTP format value and eight most significant bits (MSBs) of a fractional part of the full NTP format value.

Clause 41. The method of any of clauses 36-40, wherein the first QUIC header extension has a header extension type of “urn:3gpp:quic-delay-measurement-request:rel-21.”

Clause 42. The method of any of clauses 36-41, wherein the second QUIC header extension has a header extension type of “urn:3gpp:quic-delay-measurement-response:rel-21.”

Clause 43. A device for receiving data via a network, the device comprising one or more means for performing the method of any of clauses 1-42.

Clause 44. The device of clause 43, wherein the one or more means comprise a memory and a processing system implemented in circuitry.

Clause 45. The device of clause 43, wherein the device comprises at least one of: an integrated circuit; a microprocessor; and a wireless communication device.

Clause 46. A device for retrieving media data, the device comprising: means for receiving, during a QUIC communication session, a QUIC packet including a QUIC header extension including protocol data unit (PDU) Set signaling information, the packet corresponding to a PDU of the PDU Set; means for extracting the PDU Set signaling information from the QUIC header extension; and means for using the PDU Set signaling information from the QUIC header extension to receive subsequent data of the QUIC communication session.

Clause 47. A device for receiving media data, the device comprising: means for receiving, during a QUIC communication session, a QUIC packet including a QUIC header extension including dynamic traffic characteristics signaling information; means for extracting the dynamic traffic characteristics signaling information from the QUIC header extension; and means for using the dynamic traffic characteristics signaling information from the QUIC header extension to receive subsequent data of the QUIC communication session.

Clause 48. A method of receiving data via a network, the method comprising: receiving, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extracting the PDU Set signaling information from the QUIC header extension; and using the PDU Set signaling information from the QUIC header extension to receive subsequent data of the QUIC communication session.

Clause 49. The method of clause 48, wherein the PDU Set signaling information includes the data indicating whether the PDU is the last PDU of the PDU Set, the data indicating whether the PDU is the last PDU of the PDU Set being a single bit value.

Clause 50. The method of any of clauses 48 and 49, wherein the PDU Set signaling information includes the data indicating whether the PDU is the last PDU of the current data burst, the data indicating whether the PDU is the last PDU of the current data burst being a single bit value.

Clause 51. The method of any of clauses 48-50, wherein the PDU Set signaling information includes the PDU Set importance information, the PDU Set importance information indicating a relative importance of the PDU Set relative to other PDU Sets of the QUIC communication session.

Clause 52. The method of any of clauses 48-51, wherein the PDU Set signaling information includes the PDU Set sequence number, the PDU Set sequence number being a ten-bit value.

Clause 53. The method of any of clauses 48-52, wherein the PDU Set signaling information includes the sequence number for the PDU, the sequence number for the PDU being a six-bit value that monotonically increases for each PDU of the PDU Set.

Clause 54. The method of any of clauses 48-53, wherein the PDU Set signaling information includes the PDU Set size, the PDU Set size being a 24-bit value indicating a total size of all PDUs of the PDU Set.

Clause 55. The method of any of clauses 48-54, wherein the PDU Set signaling information includes the number of PDUs in the PDU Set, the number of PDUs in the PDU Set being a 16-bit value indicating the number of PDUs in the PDU Set.

Clause 56. The method of any of clauses 48-55, wherein the QUIC packet comprises a 1-RTT packet.

Clause 57. The method of any of clauses 48-56, further comprising exchanging negotiation data representing the QUIC header extension before receiving the QUIC packet.

Clause 58. The method of clause 57, wherein exchanging the negotiation data includes receiving an initial QUIC packet including a QUIC header extension request frame including a header extension identifier for the QUIC header extension and a definition of the QUIC header extension.

Clause 59. The method of any of clauses 57 and 58, wherein exchanging the negotiation data includes receiving an initial QUIC packet including a QUIC header extension response frame confirming support for the QUIC header extension.

Clause 60. The method of any of clauses 58 and 59, wherein the negotiation data is encrypted according to a key derived from a cleartext connection identifier and a predefined salt number.

Clause 61. The method of any of clauses 48-60, further comprising receiving protocol description data indicating that QUIC protocol applies to the QUIC communication session and how to identify QUIC packets including the PDU Set signaling information.

Clause 62. The method of any of clauses 48-61, wherein the method is performed by a user plane function (UPF) device, the method further comprising: encapsulating the QUIC packet to form a GTP-U tunneled packet; and adding data representing the PDU Set signaling information to a GTP-U header of the GTP-U tunneled packet.

Clause 63. The method of any of clauses 48-61, wherein the method is performed by a base station device, and wherein using the PDU Set signaling data comprises determining whether to drop PDUs of the PDU Set based on an importance of the PDU Set and a current amount of network congestion.

Clause 64. The method of any of clauses 48-64, wherein the QUIC header extension further includes dynamic traffic characteristics signaling information, and wherein using the PDU Set signaling information further comprises using the dynamic traffic characteristics signaling information to receive the subsequent data of the QUIC communication session.

Clause 65. The method of clause 64, wherein the dynamic traffic characteristics signaling information includes data indicating at least one of a time to next data burst (TTNB) for the QUIC communication session, an idle period value representing a lower bound on a time period during which a traffic source will not send delay-sensitive packets of the QUIC communication session via the network, or a burst size value indicating a size of a current data burst including the packet.

Clause 66. The method of any of clauses 48-65, wherein the QUIC packet comprises a first QUIC packet, and wherein receiving the first QUIC packet comprises receiving the first QUIC packet at a second time (T2) from a requesting device, the QUIC header extension comprising a first QUIC header extension including data representative of a first time (T1) at which the requesting device sent the first QUIC packet, the method further comprising sending, at a third time (T3) and to the requesting device, a second QUIC packet including a second QUIC header extension including data representative of T1, T2, and T3.

Clause 67. A device for receiving data via a network, the device comprising: a memory; and a processing system implemented in circuitry and configured to: receive, during a QUIC communication session, a QUIC packet including a QUIC header extension including protocol data unit (PDU) Set signaling information, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set; extract the PDU Set signaling information from the QUIC header extension; and use the PDU Set signaling information from the QUIC header extension to receive subsequent data of the QUIC communication session.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
receiving, during a QUIC communication session, a QUIC packet including a QUIC header extension including protocol data unit (PDU) Set signaling information for a PDU Set, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set;
extracting the PDU Set signaling information from the QUIC header extension; and
using the PDU Set signaling information from the QUIC header extension to receive subsequent data of the QUIC communication session.

2. The method of claim 1, wherein the PDU Set signaling information includes the data indicating whether the PDU is the last PDU of the PDU Set, the data indicating whether the PDU is the last PDU of the PDU Set being a single bit value.

3. The method of claim 1, wherein the PDU Set signaling information includes the data indicating whether the PDU is the last PDU of the current data burst, the data indicating whether the PDU is the last PDU of the current data burst being a single bit value.

4. The method of claim 1, wherein the PDU Set signaling information includes the PDU Set importance information, the PDU Set importance information indicating a relative importance of the PDU Set relative to other PDU Sets of the QUIC communication session.

5. The method of claim 1, wherein the PDU Set signaling information includes the PDU Set sequence number, the PDU Set sequence number being a ten-bit value.

6. The method of claim 1, wherein the PDU Set signaling information includes the sequence number for the PDU, the sequence number for the PDU being a six-bit value that monotonically increases for each PDU of the PDU Set.

7. The method of claim 1, wherein the PDU Set signaling information includes the PDU Set size, the PDU Set size being a 24-bit value indicating a total size of all PDUs of the PDU Set.

8. The method of claim 1, wherein the PDU Set signaling information includes the number of PDUs in the PDU Set, the number of PDUs in the PDU Set being a 16-bit value indicating the number of PDUs in the PDU Set.

9. The method of claim 1, wherein the QUIC packet comprises a 1-RTT packet.

10. The method of claim 1, further comprising exchanging negotiation data representing the QUIC header extension before receiving the QUIC packet.

11. The method of claim 10, wherein exchanging the negotiation data includes receiving an initial QUIC packet including a QUIC header extension request frame including a header extension identifier for the QUIC header extension and a definition of the QUIC header extension.

12. The method of claim 10, wherein exchanging the negotiation data includes receiving an initial QUIC packet including a QUIC header extension response frame confirming support for the QUIC header extension.

13. The method of claim 10, wherein the negotiation data is encrypted according to a key derived from a cleartext connection identifier and a predefined salt number.

14. The method of claim 1, further comprising receiving protocol description data indicating that QUIC protocol applies to the QUIC communication session and how to identify QUIC packets including the PDU Set signaling information.

15. The method of claim 1, wherein the method is performed by a user plane function (UPF) device, the method further comprising:
encapsulating the QUIC packet to form a GTP-U tunneled packet; and
adding data representing the PDU Set signaling information to a GTP-U header of the GTP-U tunneled packet.

16. The method of claim 1, wherein the method is performed by a base station device, and wherein using the PDU Set signaling data comprises determining whether to drop PDUs of the PDU Set based on an importance of the PDU Set and a current amount of network congestion.

17. The method of claim 1, wherein the QUIC header extension further includes dynamic traffic characteristics signaling information, and wherein using the PDU Set signaling information further comprises using the dynamic traffic characteristics signaling information to receive the subsequent data of the QUIC communication session.

18. The method of claim 17, wherein the dynamic traffic characteristics signaling information includes data indicating at least one of a time to next data burst (TTNB) for the QUIC communication session, an idle period value representing a lower bound on a time period during which a traffic source will not send delay-sensitive packets of the QUIC communication session via the network, or a burst size value indicating a size of a current data burst including the packet.

19. The method of claim 1, wherein the QUIC packet comprises a first QUIC packet, and wherein receiving the first QUIC packet comprises receiving the first QUIC packet at a second time (T2) from a requesting device, the QUIC header extension comprising a first QUIC header extension including data representative of a first time (T1) at which the requesting device sent the first QUIC packet, the method further comprising sending, at a third time (T3) and to the requesting device, a second QUIC packet including a second QUIC header extension including data representative of T1, T2, and T3.

20. A device for receiving data via a network, the device comprising:
a memory; and
a processing system implemented in circuitry and configured to:
receive, during a QUIC communication session, a QUIC packet including a QUIC header extension including protocol data unit (PDU) Set signaling information for a PDU Set, the packet corresponding to a PDU of the PDU Set, wherein the PDU Set signaling information includes one or more of data indicating whether the PDU is a last PDU of the PDU Set, whether the PDU is a last PDU of a current data burst for the PDU Set, PDU Set importance information, a PDU Set sequence number, a sequence number for the PDU within the PDU Set, a PDU Set size, or a number of PDUs in the PDU Set;
extract the PDU Set signaling information from the QUIC header extension; and
use the PDU Set signaling information from the QUIC header extension to receive subsequent data of the QUIC communication session.
